(19) United States
(12) Patent Application Publication
(10) Pub. No.: US 2019/0187382 A1
(43) Pub. Date: Jun. 20, 2019

(54) SELF-POWERED LIGHTED DUST CAPS FOR TESTING CONTINUITY; AND METHODS

(71) Applicant: COMMSCOPE TECHNOLOGIES LLC, Hickory, NC (US)

(72) Inventor: Thomas MARCOUILLER, Shakopee, MN (US)

(73) Assignee: COMMSCOPE TECHNOLOGIES LLC, Hickory, NC (US)

(21) Appl. No.: 16/326,088

(22) PCT Filed: Aug. 2, 2017
(86) PCT No.: PCT/US2017/045115

§ 371 Date: Feb. 15, 2019

Related U.S. Application Data
(60) Provisional application No. 62/375,612, filed on Aug. 16, 2016.

(51) Int. Cl. G02B 6/38; G01M 11/00

(52) U.S. Cl. CPC G02B 6/385; G01M 11/33; G02B 6/3849

(57) ABSTRACT

Aspects and techniques of the present disclosure relate to a diagnostic method for testing continuity along an optical fiber. The method can include a step of mounting a dust cap to an optical port where the dust cap includes a self-powered light for testing an optical fiber line. The method further includes a step of activating the self-powered light of the dust cap to shine a light along the optical fiber line and determining whether the light is visible downstream of the optical fiber line. The present disclosure also relates to a dust cap for an optical fiber connector in an optical system. The dust cap can be adapted to cover an end of the optical fiber connector. The dust cap includes a self-generating light source for testing connections in the optical system.

### CROSS-REFERENCE TO RELATED APPLICATION

This application is being filed on Aug. 2, 2017 as a PCT International Patent Application and claims the benefit of U.S. Patent Application Ser. No. 62/375,612, filed on Aug. 16, 2016, the disclosure of which is incorporated herein by reference in its entirety.

### TECHNICAL FIELD

The present disclosure relates generally to fiber optic cable networks. More specifically, the present disclosure relates to the components of passive optical networks and methods for deploying the same to test fiber optic continuity.

### BACKGROUND

Passive optical networks are becoming prevalent in part because service providers want to deliver high bandwidth communication capabilities to customers. Passive optical networks are a desirable choice for delivering high-speed communication data because they may not employ active electronic devices, such as amplifiers and repeaters, between a central office and a subscriber termination.

When deploying indexing terminals, there is no easy way to continuously check for product and system continuity. If it is determined that there is no connectivity in the system, it can be hard to identify where the problem lies. Thus, it would be desirable to provide a method of ascertaining true connectivity while deploying indexing terminals in an optical system.

### SUMMARY

A self-powered lighted dust cap used in an indexing system to verify connections and features thereof are described. One aspect of the present disclosure relates to a diagnostic method for testing continuity along an optical fiber. The method includes a step of mounting a dust cap to an optical port where the dust cap includes a self-generating light for testing an optical fiber line. The method further includes a step of activating the self-powered lighted dust cap to shine a light along the optical fiber line and determining whether the light is visible downstream of the optical fiber line.

Another aspect of the present disclosure relates to a diagnostic method for testing continuity along an optical fiber for a fiber indexing system. The fiber indexing system can include a plurality of indexing components daisy chained together. The plurality of indexing components can each have a first multi-fiber connection interface that defines a plurality of sequential fiber positions and a second multi-fiber connection interface that defines a plurality of sequential fiber positions. A plurality of indexing optical fibers can be connected between the first and second multi-fiber connection interfaces in an indexed configuration. The method includes the following steps: installing a first indexing component; mounting a dust cap to the first multi-fiber connection interface of the first indexing component, the dust cap including a self-powered light to test the plurality of indexing optical fibers in the fiber indexing system; activating the self-powered light of the dust cap to shine a light along the plurality of indexing optical fibers; installing a second indexing component such that the first and second multi-fiber connection interfaces of the first and second indexing components are optically coupled together; determining whether the light is visible at the first multi-fiber connection interface of the second indexing component in the fiber indexing system; installing a third indexing component such that the first and second multi-fiber connection interfaces of the second and third indexing components are optically coupled together; and determining whether the light is visible at the first multi-fiber connection interface of the third indexing component in the fiber indexing system.

A further aspect of the present disclosure relates to a dust cap for an optical fiber connector in an optical system. The dust cap can be adapted to cover an end of the optical fiber connector. The dust cap includes a self-generating light source for testing connections in the optical system.

### BRIEF DESCRIPTION OF THE DRAWINGS

FIG. 1 is a schematic diagram of an example distributed optical network including indexing terminals daisy-chained together;

FIG. 2 is a schematic diagram of an example indexing terminal suitable for use in the distributed optical network of FIG. 1;

FIG. 3 is a schematic diagram of an example telecommunications cable distribution architecture in accordance with principles of the present disclosure;

FIG. 4 is a schematic of an example indexing component shown in the telecommunications cable distribution architecture of FIG. 3 depicting a self-powered lighted dust cap;

FIG. 5 is a schematic of a fiber indexing system in accordance with the principles of the present disclosure; and

FIG. 6 is an enlarged view of a portion of the fiber indexing system shown in FIG. 5.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

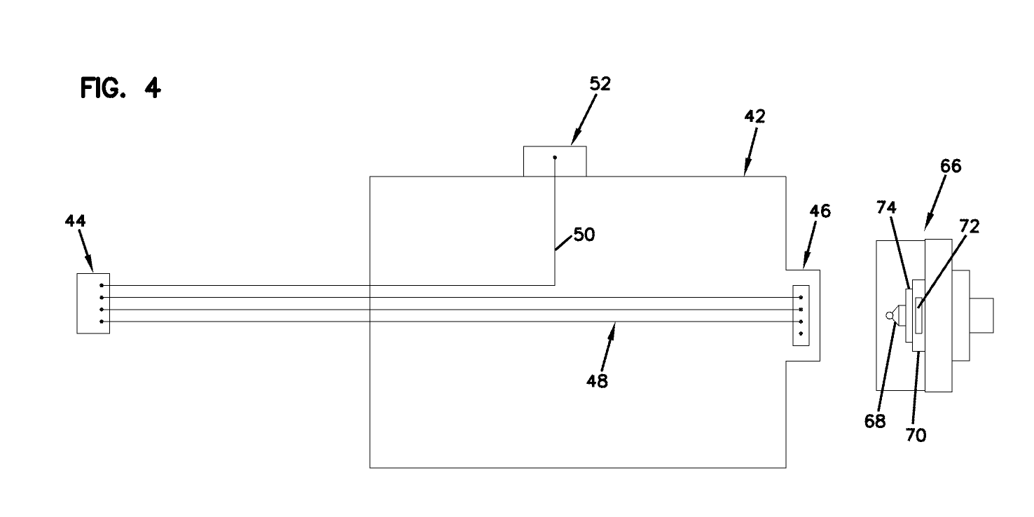

The present disclosure generally relates to an installation methodology that allows for testing true connectivity in at least a portion of an indexing system while deploying indexing terminals. The present disclosure describes a diagnostic method of using a self-generating (e.g., self-powered) lighted dust cap that emits light in an optical system to test continuity of optical fiber lines in the optical system. In one example, the self-generating lighted dust cap is described with reference to FIG. 4 in an indexing system. The self-generating lighted dust cap can be utilized to check true connectivity or continuity in the indexing system as will be disclosed in more detail herein. It will be appreciated that the self-generating lighted dust cap can be applicable to any type of optical system where it is desired to test true connectivity. An example fiber indexing system and method for deploying a fiber optic network architecture is shown in U.S. Pat. No. 9,348,096, the disclosure of which is hereby incorporated herein by reference.

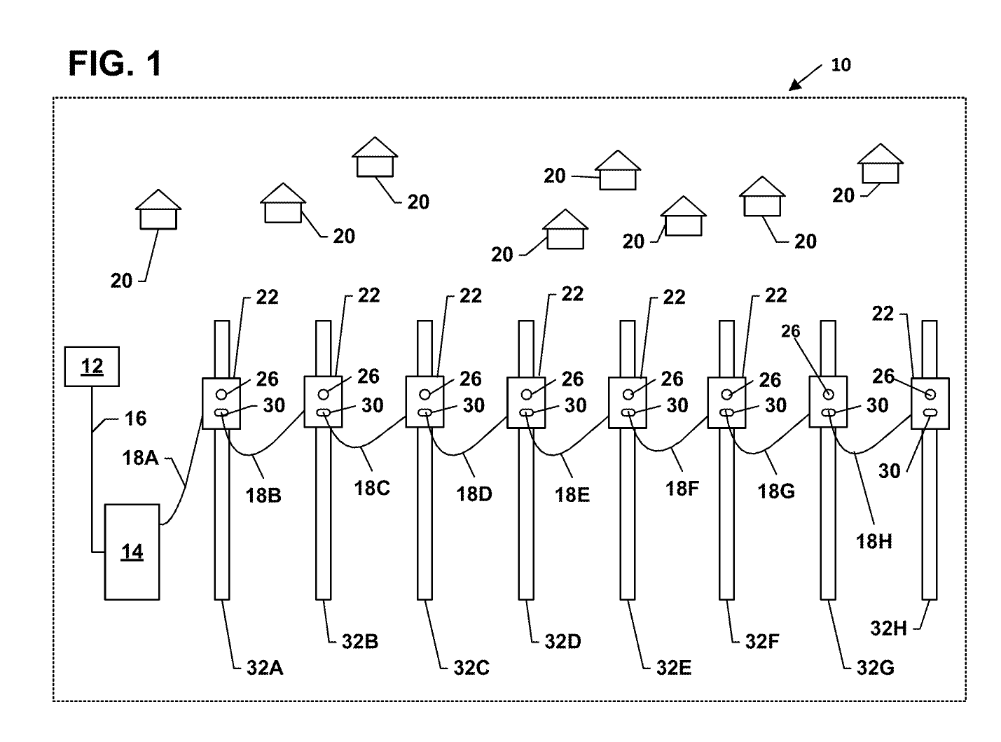

An example fiber indexing system can be described with reference to FIGS. 1-3.

FIG. 1 illustrates an example optical network 10 being deployed in accordance with the principles of the present disclosure. The example optical network 10 includes a central office 12 and at least one fiber distribution hub 14. While only a single hub 14 is shown in FIG. 1, it will be understood that optical networks 10 typically include multiple hubs. At least one feeder cable 16 extends from the central office 12 to each distribution hub 14. At the distribution hub 14, optical fiber carried by the feeder cable 16 are split onto optical fibers of one or more distribution cables 18. At least one distribution cable 18 extends from the distribution hub 14 towards subscriber premises 20.

In accordance with some aspects, the optical network 10 is a distributed optical network in which optical signals may be split at a splitting location disposed between the distribution hub 14 and the individual subscriber premises 20 as will be disclosed in more detail herein. In such systems, individual optical fibers may be broken out from the distribution cable 18 at geographic intervals and routed to the splitting locations. In various implementations, the splitting locations may be positioned at telephone poles, strands, and/or hand holes. From the splitting locations, the split optical signals are carried by drop cables to the individual subscriber premises 20.

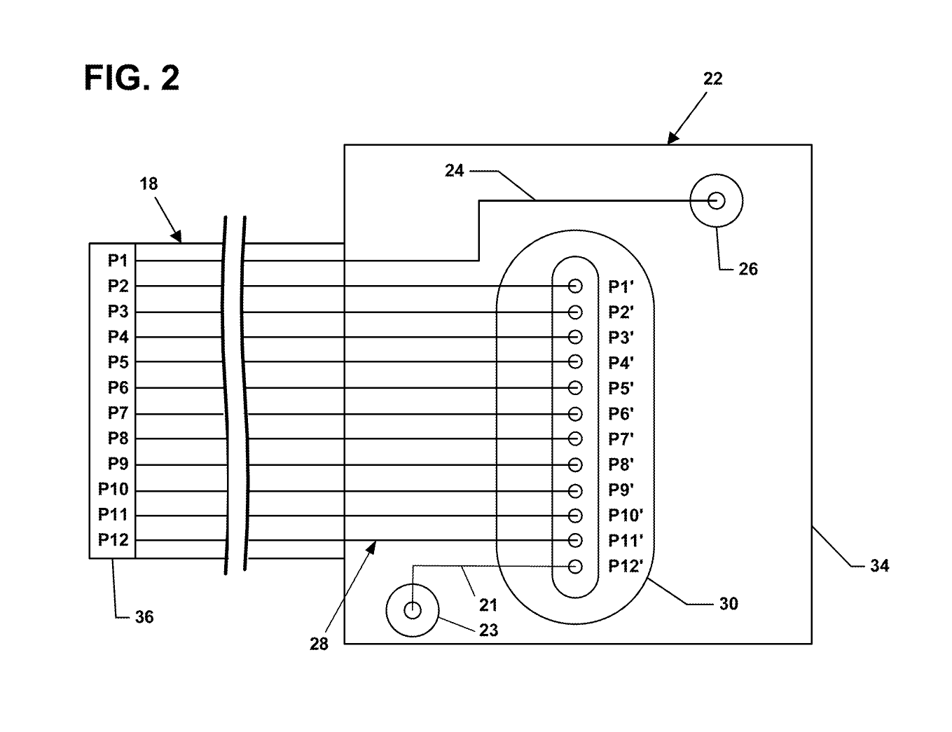

In some implementations, the individual optical fibers are broken out from the distribution cable 18 at indexing terminals 22. Each indexing terminal 22 receives a distribution cable 18 having two or more optical fibers. In some implementations, the distribution cable 18 is a stub cable that extends outwardly from the indexing terminal 22. In other implementations, the indexing terminal 22 receives a connectorized end of the distribution cable 18. In certain implementations, each indexing terminal 22 separates one of the optical fibers from other optical fibers 24 (see FIG. 2) of the distribution cable 18. The separated optical fiber 24 is routed to a first port 26 of the indexing terminal 22 and the other optical fibers 28 are routed to a second port 30 of the indexing terminal 22 (e.g., see FIG. 2). A dead indexing optical fiber corresponding to an inactive fiber position P12′ may also be routed from the second port 30 such that the dead indexing optical fiber may be optically connected to a reverse drop fiber 21 at a reverse drop location 23.

In the example shown in FIG. 1, a first distribution cable 18A is routed from the distribution hub 14 to a mounting structure (e.g., telephone pole) 32A at which the indexing terminal 22 is mounted. A second distribution cable 18B extends from the indexing terminal 22 at the first mounting structure 32A to another indexing terminal mounted at a second mounting structure 32B. In the distributed network 10 shown in FIG. 1, indexing terminals 22 are mounted to eight poles 32A-32H. These indexing terminals 22 are daisy-chained together using distribution cables 18A-18H as will be described in more detail herein. In other implementations, however, distributed networks may include a greater or lesser number of indexing terminals 22.

FIG. 2 illustrates an example indexing terminal 22 suitable for use in the distributed optical network 10 of FIG. 1. The indexing terminal 22 includes a housing 34 that defines the first port 26 and the second port 30. In the example shown, the stub distribution cable 18 extends outwardly from the indexing terminal housing 22. The stub distribution cable 18 includes multiple optical fibers that are connectorized at an end opposite the indexing terminal housing 34. In the example shown, the stub distribution cable 18 includes twelve optical fibers. In other implementations, however, the stub distribution cable 18 may include a greater or lesser number of optical fibers (e.g., four, six, eight, ten, sixteen, twenty-four, seventy-two, etc.).

In certain implementations, the optical fibers of the stub distribution cable 18 extend from first ends to a second ends. The first ends of the fibers are connectorized at a multi-fiber connector 36 (e.g., an MPO-type connector). In the example shown, the first ends of the fibers are connectorized at a ruggedized multi-fiber connector (e.g., an HMFOC-connector). As the terms are used herein, ruggedized optical connectors and ruggedized optical adapters are configured to mate together to form an environmental seal. Some non-limiting example ruggedized optical connector interfaces suitable for use with an indexing terminal 22 are disclosed in U.S. Pat. Nos. 7,744,288, 7,762,726, 7,744,286, 7,942,590, and 7,959,361, the disclosures of which are hereby incorporated herein by reference.

The connector 36 indexes the first end of each optical fiber at a particular position relative to the other fibers. In the example shown, the connector 36 indexes each of the twelve optical fibers into one of twelve positions P1-P12. The second port 30 has the same number of fiber positions as the connector 36. In the example shown, the second port 30 has twelve fiber positions P1′-P12′ that correspond with the fiber positions P1-P12 of the connector 36.

In one example, a first one 24 of the optical fibers has a first end located at the first position P1 of the connector 36. The second end of the first optical fiber 24 is separated out from the rest of the optical fibers 28 within the indexing terminal housing 34 and routed to the first port 26 at which optical signals carried by the first optical fiber 24 may be accessed. In some implementations, the first port 26 defines a female port at which an optical fiber plug may be mated to the first optical fiber 24. In certain implementations, the first port 26 includes a ruggedized (i.e., hardened) optical adapter configured to receive a ruggedized optical connector (e.g., an HMFOC).

The remaining optical fibers 28 are routed to the second port 30. At least one of the fiber positions P1′-P12′ does not receive an optical fiber 28 since at least one optical fiber 24 is diverted to the first port 26. However, the second port 30 indexes the received optical fibers 28 so that a first position P1′ at the second port 30 that corresponds with the first position P1 of the connector 36 does receive one of the optical fibers 28. In accordance with aspects of the disclosure, when the indexing terminals 22 are daisy-chained together as shown in FIG. 1, the optical fiber 24 diverted to the first port 26 will be pulled from the same position P1-P12. Also, the remaining fibers 28 will be cabled so that the corresponding position P1′-P12′ at the second port 30 will receive one of the optical fibers 28 if any are available.

In the example shown, the separated optical fiber 24 is located at an end of the row/strip of fibers. Accordingly, the optical fibers 28 are cabled within the indexing terminal housing 34 to divert the second end of each optical fiber 28 over one indexed position P1′-P12′ compared to the first end. For example, a fiber 28 having a first end at position Pn of the connector 36 would have a second end at position P(n−1)′ at the second port 30. In the example shown, the optical fiber 28 having a first end at the second position P2 of the connector 36 will have a second end disposed at the first position P1′ of the second port 30. Likewise, the optical fiber 28 having a first end at disposed the third position P3 of the connector 36 will have a second end disposed at the second position P2′ of the second port 30. The optical fiber 28 having a first end at the twelfth position P12 of the connector 36 will have a second end disposed at the eleventh position P11′ of the second port 30. The twelfth position P12′ of the second port 30 will not receive an optical fiber. In other implementations, the optical fiber at any of the positions P1-P12 may be separated out from the rest as long as each indexing terminal separates out a fiber from the same position. It will be appreciated that the second end of each optical fiber 28 can be diverted over more than one indexed position P1′-P12′ compared to the first end in a repeated pattern.

Such a cabling configuration enables the indexing terminals to be daisy-chained together using identical components while always delivering the next fiber in line to the first port 26. For example, in FIG. 1, the stub distribution cable 18B of the second indexing terminal 22 mounted to the second pole 32B may be routed to and plugged into the second port 30 of the first indexing terminal 22 mounted to the first pole 32A. The stub distribution cable 18A of the first indexing terminal 22 may be routed to the distribution hub 14 to receive split optical signals from the feeder cable 16. Accordingly, the split optical signals carried by the first optical fiber 24 of the first stub distribution cable 18A are routed to the first port 26 of the first indexing terminal 22. The split optical signals carried by the remaining optical fibers 28 of the first stub distribution cable 18A are routed to positions P1′-P11′ of the second port 30 of the first indexing terminal 22.

At the second port 30, the second optical fiber 28 of the first stub cable 18A is mated with the first optical fiber 24 of the second stub cable 18B. The first optical fiber 24 of the second stub cable 18B is routed to the first port 26 of the second indexing terminal. Accordingly, the split optical signals carried by the second optical fiber 28 of the first stub cable 18A propagate to the first optical fiber 24 of the second stub cable 18B and are accessible at the second port 30 of the second indexing terminal 22. Likewise, the split optical signals carried by the sixth optical fiber 28 of the first stub cable 18A propagate to the fifth optical fiber 24 of the second stub cable 18B, the fourth optical fiber 28 of the third stub cable 18C, the third optical fiber 28 of the fourth stub cable 18D, the second optical fiber 28 of the fifth stub cable 18E, and the first optical fiber 24 of the sixth stub cable 18F and are accessible at the second port 30 of the sixth indexing terminal 22.

In alternative implementations, the distribution cable 18 is not a stub cable and the indexing terminal housing 38 defines an input port (e.g., an HMFOC port) configured to receive a second connectorized end of the distribution cable 18. In such implementations, internal cabling between the input port and the second port 30 is implemented as described above. Accordingly, the optical fiber coupled to a first position at the input port is routed to the first port 26 and the optical fiber coupled to a second position at the input port is routed to a first position at the second port 30. In such implementations, each distribution cables 18 would include twelve optical fibers that are connectorized at both ends. The first end of each distribution cable 18 would mate with the input port of one indexing terminal. The second end of each distribution cable 18 would mate with the second port 30 of another indexing terminal.

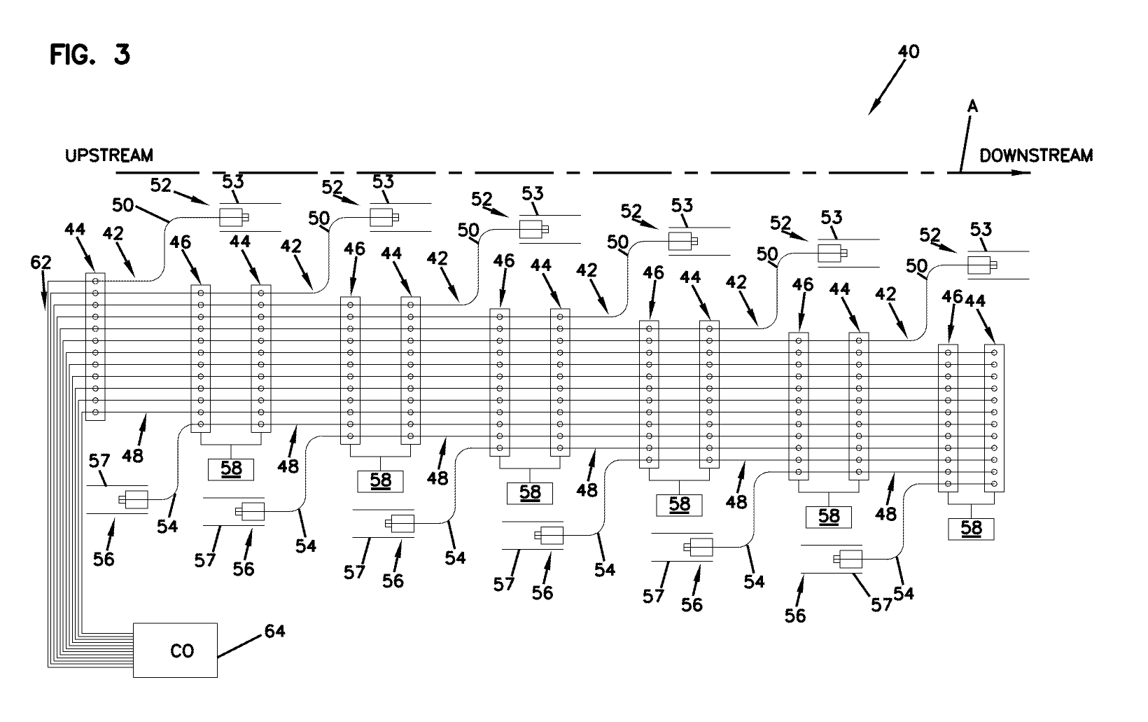

Referring to FIG. 3, an example telecommunications cable distribution architecture 40 is shown. The telecommunications cable distribution architecture 40 can include a plurality of indexing components 42. Each one of the plurality of indexing components 42 can include a first multi-fiber connection interface 44 defining a plurality of sequential fiber positions and a second multi-fiber connection interface 46 defining a plurality of sequential fiber positions.

The telecommunications cable distribution architecture 40 further includes a plurality of indexing optical fibers 48 connected between the first and second multi-fiber connection interfaces 44, 46 in an indexed configuration. A feeder distribution cable 62 (e.g., main cable) may be associated at one end with a central office 64. The cable 62 may have on the order of 12 to 48 fibers; however, alternative implementations may include fewer or more fibers. The cable 62 shown has 12 fibers that each have an end associated with the central office 64. The central office 64 may connect a number of end subscribers 20 (e.g., end users). In certain examples, the central office 64 may also connect to a larger network such as the Internet (not shown) and a public switched telephone network (PSTN). The various lines of the network can be aerial or housed within underground conduits.

In certain examples, forward drop fibers 50 may be routed from the first multi-fiber connection interfaces 44 of indexing components 42 in the architecture 40 to forward drop locations 52 where they are connected into adapter ports 53. In certain examples, a second connector (not shown) may be plugged or connected into the adapter ports 53 and routed to the individual subscriber premises 20.

The plurality of indexing components 42 can be daisy chained together end-to-end in an upstream to downstream direction as shown by arrow A with first multi-fiber connection interfaces 44 of each indexing component 42 being positioned upstream from its corresponding second multi-fiber connection interface 46. The first and second multi-fiber connection interfaces 44, 46 of adjacent indexing components 42 in the daisy chain can be optically coupled together.

In FIG. 3, a mechanical coupling 58 is schematically shown to indicate the coupling of the first and second multi-fiber connection interfaces 44, 46 of adjacent indexing components 42 in the daisy chain.

In some examples, reverse drop fibers 54 may also be routed from the second multi-fiber connection interfaces 46 of the indexing components 42 in the architecture 40 to reverse drop locations 56 where they can be connected into adapter ports 57.

Referring to FIG. 4, a schematic of an example indexing component 42 is shown. A dust cap (e.g., device) 66 can be configured to mount onto a ruggedized optical connector (e.g., an HMFOC) or a ruggedized (i.e., hardened) optical adapter, although alternatives are possible. In certain examples, the dust cap 66 can be mounted onto a single fiber connector.

The dust cap 66 can be mounted onto the indexing component 42 at the second multi-fiber connection interface 46. In one example, the dust cap 66 can be secured to the indexing component 42 by a threaded connection. For example, the dust cap 66 can have internal threads (not shown) that mate with external threads (not shown) of the indexing component 42 to secure the dust cap 66 on the indexing component 42.

In the example shown, the dust cap 66 includes a self-generating light source 68 (e.g., self-powered light source) to emit light through the optical fibers sequentially positioned in the indexing component 42. In one example, the self-generating light source 68 can be a light emitting diode (LED), although alternatives are possible. For example, the dust cap 66 may include self-generating laser light source.

The dust cap 66 may include a battery holder 70 (e.g., clip) for securing a battery 72 therein for powering the self-generating light source 68. The dust cap 66 may include a printed circuit board assembly 74 (PCBA) to mechanically support and electrically connect the self-generating light source 68, although alternatives are possible. The PCBA 74 is shown positioned between the battery holder 70 and the self-generating light source 68.

The dust cap 66 generates its own light such that when connected to the indexing component 42, light is pushed through a HMFOC or single connector to test the fiber optic lines for true connectivity. In FIG. 4, the dust cap 66 shines self-emitting or self-generating light through positions P2-P4 of the indexing component 42 to test the indexing optical fibers 48 for true connectivity.

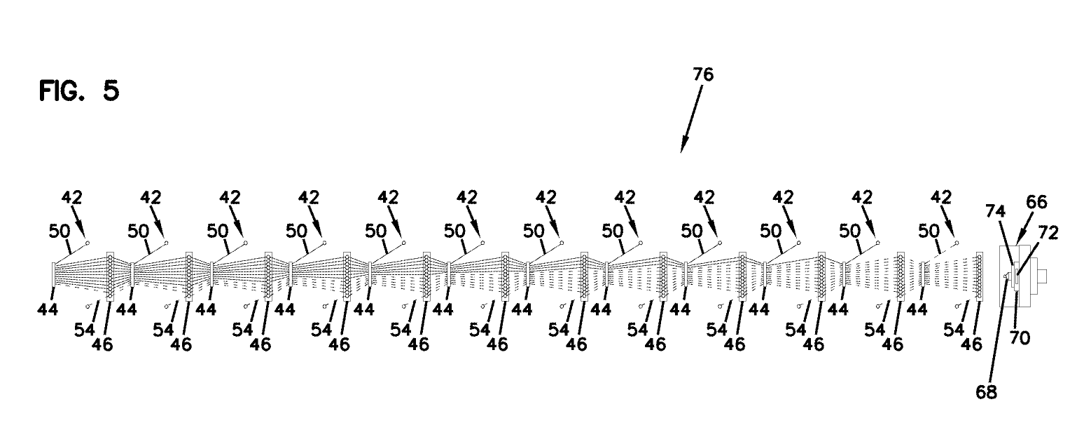

Referring to FIG. 5, a schematic of an example fiber indexing system 76 is depicted. The fiber indexing system 76 shows an example method of installation of the indexing components 42. When deploying the indexing components 42, the components 42 are deployed from the downstream end where an installer would work backwards towards the central office 64. Typically in a fiber indexing system, testing of fiber optic lines for true continuity occurs after the installation process. Thus, if there is an issue with continuity, trouble shooting is required to determine where the issue lies in the system. If an indexing terminal needs replacing, the terminals already deployed would be taken down.

In the depicted fiber indexing system 76, the dust cap 66 can be mounted at a tail end of the fiber indexing system 76 having a plurality of the indexing components 42 daisy chained together, although alternatives are possible. For example, the dust cap 66 can be mounted over any one of the indexing components 42 individually. In other examples, the dust cap 66 can be mounted onto a single fiber for testing purposes. For example, the dust cap 66 can be mounted onto the forward drop fibers 50 or reverse drop fibers 54 to test for true continuity.

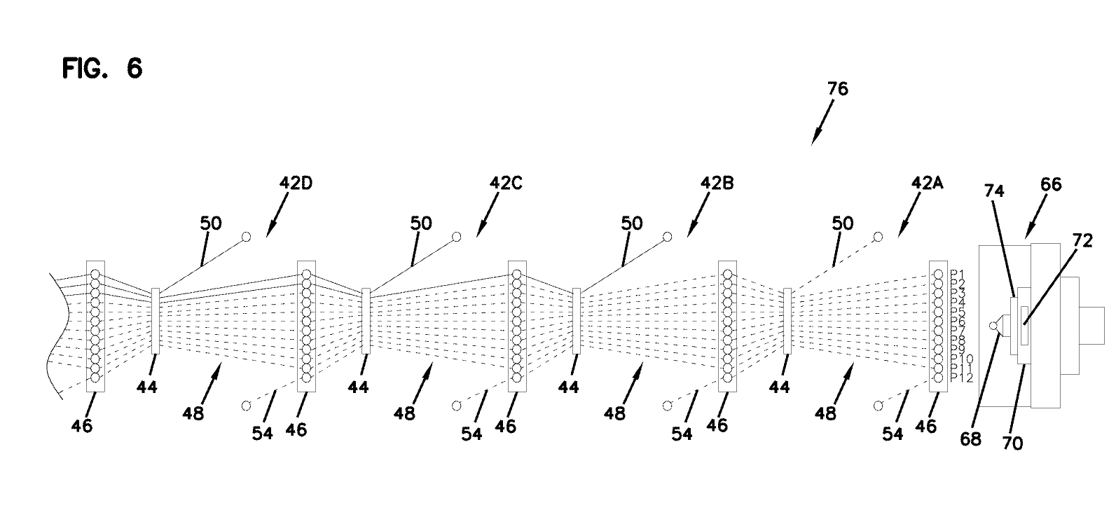

Referring to FIG. 6, an enlarged view of a portion of the fiber indexing system 76 shown in FIG. 5 is shown. The dust cap 66 is arranged and configured to mount onto the second multi-fiber connection interface 46 of the downstream-most indexing component 42A. The self-generating light source of the dust cap 66 passes through the indexing optical fibers 48 of the indexing component 42A to test for true continuity along the plurality of sequential fiber positions P1-P12. Accordingly, verification of light on the HMFOC connector can be provided for the downstream-most indexing component 42A in the fiber indexing system 76. As depicted, the forward drop fibers 50 and the reverse drop fibers 54 progressively dropped in the fiber indexing system 76 are no longer visible through the dust cap 66. However, it will be appreciated that the dust cap 66 can be arranged and configured to mount separately onto the forward and reverse drop fibers 50, 54 to test for true continuity or connection. In certain examples, the dust cap 66 can be mounted onto an optical port for testing true continuity of an optical fiber line.

When installing additional indexing components 42B, 42C, 42D, progressively backwards from the downstream end, the self-generating light source 68 of the dust cap 66 emits light that continues to pass through the indexing optical fibers 48 of the indexing component 42A to the next indexing component 42B that is installed in the network. Such a configuration allows for verification of continuity or connections throughout the “daisy chaining” process of installing indexing components 42C, 42D etc. It will be appreciated that the dust cap 66 may be utilized in a fiber indexing system that is deployed in a direction from the upstream end to the downstream end.

While we show the dust cap 66 utilized in a fiber indexing system, the dust cap 66 may also be applicable in any type of optical system having a port or connector where testing true continuity is desirable.

In one example, the dust cap 66 can be designed to remain on the indexing component 42 and the battery is allowed to run dead. Leaving the dust cap 66 on eliminates the need for a technician to come back to the terminal to remove the dust cap 66. It will be appreciated that verification of light on the connector end can take place in the field prior to deploying each terminal, on a spool or in a coiled state.

Another aspect of the present disclosure relates to a diagnostic method for testing continuity along an optical fiber. The method includes a step of mounting a dust cap 66 to an optical port. The dust cap 66 can include the self-generating light source 68 for testing an optical fiber line. The method can further include a step of activating the self-generating light source 68 of the dust cap 66 to shine a light along the optical fiber line. The method includes a step of determining whether the light is visible downstream of the optical fiber line.

The present disclosure further relates to a diagnostic method for testing continuity along an optical fiber for the fiber indexing system 76. The fiber indexing system 76 includes the plurality of indexing components 42 daisy chained together. The plurality of indexing components 42 can each have the first multi-fiber connection interface 44 that defines a plurality of sequential fiber positions and the second multi-fiber connection interface 46 that defines a plurality of sequential fiber positions. A plurality of indexing optical fibers 48 can be connected between the first and second multi-fiber connection interfaces 44, 46 in an indexed configuration.

The method includes the steps of: 1) installing the first indexing component 42A; 2) mounting the dust cap 66 to the first multi-fiber connection interface 44 of the first indexing component 42A where the dust cap 66 includes the self-generating light source 68 to test the plurality of indexing optical fibers 48 in the fiber indexing system 76; 3) activating the self-generating light source 68 of the dust cap 66 to shine a light along the plurality of indexing optical fibers 48; 4) installing a second indexing component 42B such that the first and second multi-fiber connection interfaces 44, 46 of the first and second indexing components 42A, 42B are optically coupled together; 5) determining whether the light is visible at the first multi-fiber connection interface 44 of the second indexing component 42B in the fiber indexing system 76; 6) installing a third indexing component 42C such that the first and second multi-fiber connection interfaces 44, 46 of the second and third indexing components 42B, 42C are optically coupled together; and 7) determining whether the light is visible at the first multi-fiber connection interface 44 of the third indexing component 42C in the fiber indexing system 76.

The present disclosure also relates to the dust cap 66 for an optical fiber connector in an optical system. The dust cap 66 can be adapted to cover an end of the optical fiber connector. The dust cap 66 includes a self-generating light source 68 for testing connections in the optical system.

The principles, techniques, and features described herein can be applied in a variety of systems, and there is no requirement that all of the advantageous features identified be incorporated in an assembly, system or component to obtain some benefit according to the present disclosure.

From the forgoing detailed description, it will be evident that modifications and variations can be made without departing from the spirit and scope of the disclosure.

What is claimed is:

1. A diagnostic method for testing continuity along an optical fiber; the method comprising:
mounting a dust cap to an optical port, the dust cap including a self-powered light for testing an optical fiber line;
activating the self-powered light of the dust cap to shine a light along the optical fiber line; and
determining whether the light is visible downstream of the optical fiber line.

2. The diagnostic method of claim 1, wherein the step of mounting the dust cap includes mounting the dust cap to an adapter port.

3. The diagnostic method of claim 1, wherein the step of mounting the dust cap includes mounting the dust cap on an optical connector.

4. The diagnostic method of claim 1, further comprising a step of mounting the dust cap to an indexing component in a fiber indexing system.

5. A diagnostic method for testing continuity along an optical fiber for an fiber indexing system, the fiber indexing system including a plurality of indexing components daisy chained together, the plurality of indexing components each having a first multi-fiber connection interface that defines a plurality of sequential fiber positions and a second multi-fiber connection interface that defines a plurality of sequential fiber positions, and a plurality of indexing optical fibers connected between the first and second multi-fiber connection interfaces in an indexed configuration, the method comprising:
installing a first indexing component;
mounting a dust cap to the first multi-fiber connection interface of the first indexing component, the dust cap including a self-powered light to test the plurality of indexing optical fibers in the fiber indexing system;
activating the self-powered light of the dust cap to shine a light along the plurality of indexing optical fibers;
installing a second indexing component such that the first and second multi-fiber connection interfaces of the first and second indexing components are optically coupled together;
determining whether the light is visible at the first multi-fiber connection interface of the second indexing component in the fiber indexing system;
installing a third indexing component such that the first and second multi-fiber connection interfaces of the second and third indexing components are optically coupled together; and
determining whether the light is visible at the first multi-fiber connection interface of the third indexing component in the fiber indexing system.

6. The diagnostic method of claim 5, wherein the plurality of indexing components is hardened connectors.

7. The diagnostic method of claim 5, wherein the plurality of sequential fiber positions includes at least 6 sequential fiber positions.

8. The diagnostic method of claim 5, wherein the plurality of sequential fiber positions includes at least 12 sequential fiber positions.

9. The diagnostic method of claim 5, further comprising a step of determining whether the light is visible at the first multi-fiber connection interface of the first indexing component in the fiber indexing system.

10. A dust cap for an optical fiber connector in an optical system, the dust cap adapted to cover an end of the optical fiber connector, the dust cap comprising:
a self-generating light source for testing connections in the optical system.

11. The dust cap of claim 10, wherein the self-generating light source is a LED light.

12. The dust cap of claim 10, wherein the optical system is a fiber indexing system.
